(19) United States
(12) Patent Application Publication
(10) Pub. No.: US 2022/0026949 A1
(43) Pub. Date: Jan. 27, 2022

(54) ELECTRONIC DEVICE SUPPORT STRUCTURES

(71) Applicant: HEWLETT-PACKARD DEVELOPMENT COMPANY, L.P., SPRING, TX (US)

(72) Inventors: YI-TE LIU, TAIPEI CITY (TW); WEN-HSIANG CHEN, TAIPEI CITY (TW); HUNG-WEN CHANG, TAIPEI CITY (TW)

(21) Appl. No.: 17/296,671

(22) PCT Filed: Dec. 14, 2018
(86) PCT No.: PCT/US2018/065692

§ 371 Date: May 25, 2021

(51) Int. Cl. G06F 1/16; G06F 1/20

(52) U.S. Cl. CPC G06F 1/166; G06F 1/206; G06F 1/1616

(57) ABSTRACT

An example support structure for a laptop computer is disclosed. The support structure is extendable and connected to the rear surface of the laptop. The support structure has conduits, a foot assembly, and pairs of magnets. The foot assembly includes a foot section and a connection member. The pair of magnet holds the connection member in a way that the foot remains at a closed or retracted position, and the second pair magnet holds the connection member in a way that the foot remains in an open or extended position. The support structure also has a heat dissipation section under the foot which enhances the heat dissipation property of the laptop when the foot is in the open or extended position.

### BACKGROUND

Laptop computers, sometimes also referred to as notebook computers, are extensively used for all purposes globally. People use electronic devices like laptop computers, tablets at various locations like office, home, etc.

### BRIEF DESCRIPTION OF THE DRAWINGS

Some examples of the present application are described with respect to the following figures:

FIG. 1 illustrates a side view of a laptop computer with a support structure in a closed position, according to an example.

FIG. 2 illustrates a side view of a laptop computer with a support structure in an extended position, according to the example.

FIG. 3 illustrates a laptop housing with a support structure in a closed position, according to the example.

FIG. 4 illustrates a laptop housing with a support structure in an extended position, according to the example.

FIG. 5 illustrates a closed position of a support structure, according to the example.

FIG. 6 illustrates an extended position of a support structure, according to the example.

FIG. 7 illustrates an embodiment of a support structure, according to the example.

FIG. 8 illustrates an inner view of an embodiment of the support structure, according to the example.

FIG. 9 illustrates an inner view of a support structure with foot assembly in a closed position according to the example.

FIG. 10 illustrates an inner view of a support structure with foot assembly in an extended position, according to the example.

### DETAILED DESCRIPTION

Some of the laptop computers, notebook computers or other types of computing devices available in the market have fixed rubbers pads placed at each corner of the rear surface of the device as a support structure for the device. The rubber pads provide a small air gap between the rear surface and the surface on which the device is placed. Due to the small gap, the heat dissipation may be limited and also a user is not able to change the elevation of the device as the rubber pads are fixed with the rear surface.

Examples described herein provide an approach to provide support to an electronic device. For example, an electronic device may include a housing. The electronic device may also include a support structure attached to the housing, The support structure may include a conduit in contact with a surface of the electronic device. The support structure may also include an extension assembly connected to the conduit, where the extension assembly comprises a foot section and a connection member. The support structure may further include a first magnet and a second magnet, where the first magnet is to hold the connection member in a first position, and where the second magnet is to hold the connection member in a second position.

In another example, an electronic device may include a housing, a retractable foot attached to a surface of the housing, where the retractable foot extends laterally with respect to the surface. The electronic device may also include a heat dissipation section at the surface, where the retractable foot is to cover the heat dissipation section in a first position.

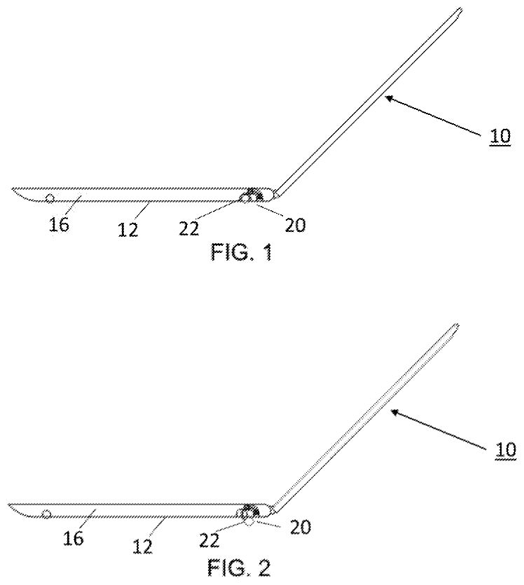

FIG. 1 illustrates a side view of an electronic device 10 with a support structure 20. In some examples, the electronic device 10 may be a laptop computer. The support structure 20 is attached at a rear surface 12 of a housing 16 of the laptop computer 10. The support structure 20, as shown in FIG. 1, is in a closed position. In an example, the closed position of the support structure 20, is called as a retracted position. In the retracted position, the support structure 20 resides in the housing 16 of the laptop computer 10 in a way that a foot 22 of the support structure 20 is not extended beyond the rear surface 12 of the housing 16 of the laptop computer 10, as shown in FIG. 1.

FIG. 2 illustrates a side view of the laptop computer 10 with the support structure 20, same as shown in FIG. 1. The support structure 20, of FIG. 2, is in an open position. In an example, the open position of the support structure 20, is called as an extended position. In the extended position, the support structure 20 extends out from the housing 16 of the laptop computer 10 in a way that the foot 22 of the support structure 20 is extended beyond the rear surface 12 of the housing 16 to provide support for the laptop computer 10, as shown in FIG. 2.

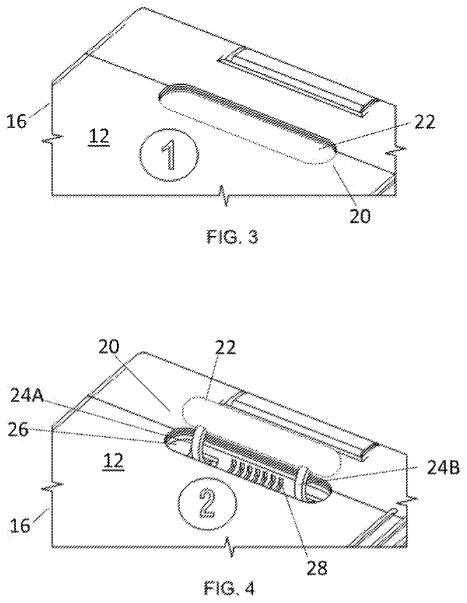

FIG. 3 illustrates the rear surface 12 of the housing 16 of the laptop computer 10 when the support structure 20 is in the closed position, according to an example. In the closed position, the support structure 20 resides in the housing 16 of the laptop computer 10 such that the foot 22 of the support structure 20 is in the same plane as the rear surface 12 of the housing 16 of the laptop computer 10, as shown in FIG. 3.

FIG. 4 illustrates the rear surface 12 of the housing 16 of the laptop computer 10 when the support structure 20 is in the open position, according to an example. In the open position, a foot 22 of the support structure 20 extends laterally with respect to the rear surface 12 of the housing 16 of the laptop computer 10. The foot 22 is made of a soft material like, but not limited to, rubber, according to an example. The foot 22 is attached to the rear, surface 12 of the laptop computer 10 through a conduit, not shown in FIG. 4, by connection members 24A, 24B, as shown in FIG. 4. The foot 22 and the connection members 22A, 246 collectively form an extension assembly, according to another example. The support structure 20, illustrated in FIG. 3 and FIG. 4, is for exemplary purposes. In accordance to an example, two or more support structures 20 are attached at one or more surfaces of the housing 16 of the laptop computer 10 shown in figures,

When the support structure 20 moves from a retracted position, shown in FIG. 3, to an extended position, shown in FIG. 4, a groove 26 is formed on the rear surface 12 of the laptop computer 10, as illustrated in FIG. 4. The shape, and size of the groove 26 is such that the foot 22 fits inside the groove 26 in the closed position which in turns keep the foot 22 of the support structure 20 in same plane as the rear surface 12 of the housing 16 of the laptop computer 10, as shown in FIG. 3, which maintains the aesthetics of the device. Also, the groove 26 has heat dissipation section 28 for dissipating heat of the laptop computer 10. The heat dissipation section 28 is covered when the foot 22 is in the closed position, as shown in FIG. 3, and the heat dissipation section 28 is exposed when the foot 22 is in open position, as illustrated in FIG. 4. In accordance to an example, the housing 16 of the laptop computer 10 has heat dissipation points and the heat dissipation section 28 acts as additional heat dissipation points that is operational when the foot 22 is in an open position.

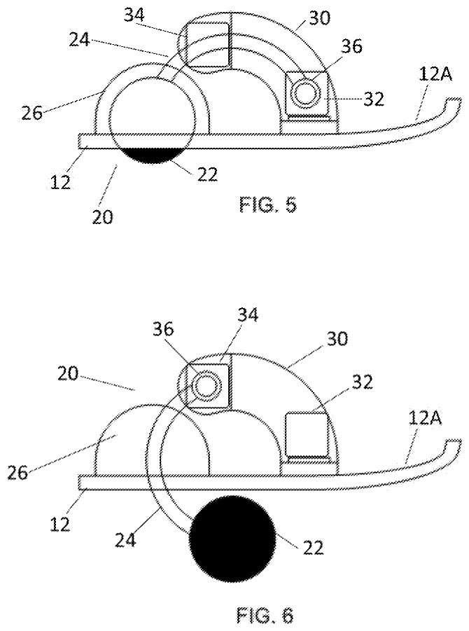

FIG. 5 and FIG. 6 illustrate the support structure 20 in the retracted position and the extended position respectively. FIG. 5 illustrates an internal side 12A of the rear surface 12 of the laptop computer. The internal side 12A of the rear surface 12 has a conduit 30 of the support structure 20. The conduit 30 resides inside the rear surface 12 of the laptop computer. The conduit 30 includes magnets 32, 34 and connection member end 36 of the connection member 24. The connection member end 36 of the connection member 24 is capable of a movement between the magnets 32, 34. In FIG. 5, the magnet 32 holds the connection member end 36 of the connection member 24 which in effect keeps the foot 22 within the groove 26. In other words, when the magnet 32 grips the connection member end 36, the foot 22 of the support structure 20 gets in a closed or retracted position, as shown in FIG. 5.

FIG. 6 shows the internal side 12A of the rear surface 12 of the laptop computer 10, shown in FIG. 1 and FIG. 2. In accordance to FIG. 6, the internal side 12A of the rear surface 12 has the conduit 30 of the support structure 20 which includes magnets 32, 34 and connection member end 36 of the connection member 24, as explained in FIG. 5. In FIG. 6, the magnet 34 holds the connection member end 36 which in effects keeps the foot 22 outside the groove 26. In other words, when the magnet 34 grips the connection member end 36, the foot 22 of the support structure 20 gets in an open or extended position, as shown in FIG. 6.

The magnets 32. 34 grips the connection member end 36 of the connection member 24 through magnetic effect, According to an example, the magnets 32, 34 are the pair of magnets 32, 34 to hold the connection member end 36 of the connection member 24 in a particular position. According to another example, a mechanical, an electrical, magnetic, an electromechanical, and/or a combination of holding mechanisms can be used to grip the connection member end 36 of the connection member 24 at a particular position in the conduit 30.

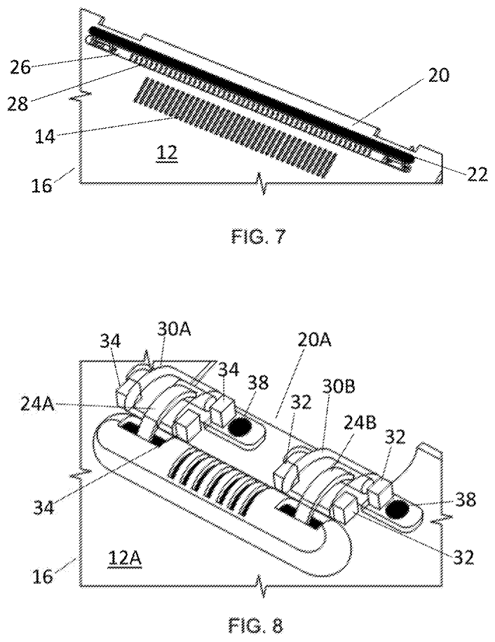

FIG. 7 illustrates an exemplary support structure 20. In the example, the support structure 20 is extended across an edge of the rear surface 12 of the housing 16 of the laptop computer 10. The rear surface 12 also includes a heat dissipation area 14. The groove 26, along with the heat dissipation section 28, is also extended across the edge of the rear surface 12 and is visible when the foot 22 of the support structure 20, shown in FIG. 7, is in an extended position. The heat dissipation section 28 provides an additional heat dissipation capability to the laptop in addition to the heat dissipation section 14. Thus, as the heat dissipation section 28 is extended across the edge of the rear surface 12 of the housing 16 of the laptop computer 10, the heat dissipation capability of the laptop computer 10 may be enhanced.

FIG. 8 illustrates an inner side 12A of the rear surface 12 of the housing 16 of the laptop computer as an example of the support structure. The internal structure 20A of the support structure is connected to the inner side 12A of the rear surface of the laptop computer. The internal structure 20A of the support structure includes conduits 30A, 30B, magnets 32, 34 and connection members 24A, 24B. The connection members 24A, 24B are capable of guided movement within the conduits 30A, 30B. At each end of the conduits 30A, 30B a pair of magnets 32, 34 are connected to hold the connection members 24A, 24B at a closed or an open position, as required by the user. The conduits 30A, 30B are attached to the inner side 12A of the rear surface, of the laptop computer, with the help of screws 38, as shown in FIG. 8.

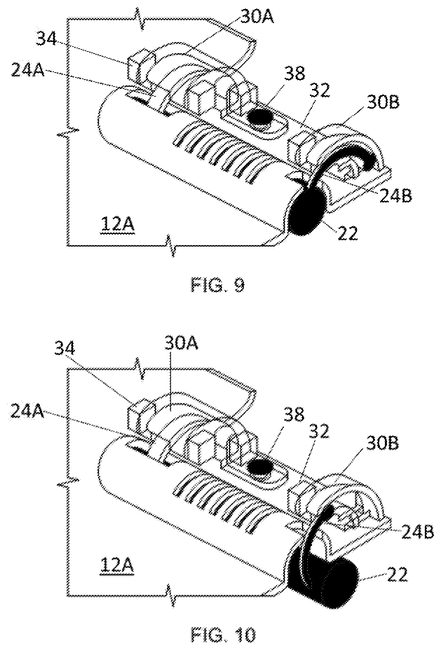

FIG. 9 illustrates an inner view of a support structure 20 with foot assembly in a closed position. The foot assembly includes foot 22 and connection members 24A, 24B, An example illustrated in FIG. 9 includes conduits 30A, 30B to facilitate a guided movement of the connection members 24A, 24B. The support structure 20 of FIG. 9 also includes grip assembly to hold the connection members 24A, 24B of the foot assembly at a particular position. The grip assembly has set of magnets 32, 34 that grips the connection members 24A, 24B at particular positions. In FIG. 9, the foot 22 of the foot assembly is in a closed or retracted position which is achieved by holding the connection members 24A, 24B at a first position, i.e. an end of the conduits 30A, 30B, with the help of first pairs of magnets 32, 34.

FIG. 10 illustrates an inner view of a support structure with foot assembly in an extended position as the example explained in FIG. 9. In FIG. 10, the foot 22 of the foot assembly is in open or extended position which is achieved by holding the connection members 24A, 24B at a second position, i.e. another end of the conduits 30A, 30B, with the help of other pairs of magnets 32, 34.

What is claimed is:

1. An electronic device, comprising:
a housing; and
a support structure attached to the housing, wherein the support structure includes:
a conduit in contact with a surface of the electronic device;
an extension assembly connected to the conduit, wherein the extension assembly comprises a foot section and a connection member; and
a first magnet and a second magnet, wherein the first magnet is to hold the connection member in a first position, and wherein the second magnet is to hold the connection member in a second position.

2. An electronic device according to claim 1, further comprising screws to connect the conduit with the surface of the electronic device.

3. An electronic device according to claim 1 wherein the surface of the electronic device has a heat dissipation section.

4. An electronic device according to claim 3 wherein the heat dissipation section is covered when the connection member is in the first position.

5. An electronic device according to claim 3 wherein the heat dissipation section is exposed when the connection member is in the second position.

6. An electronic device according to claim 1 wherein the foot section of the extension assembly is made of rubber.

7. An electronic device, comprising:
a housing;
a retractable foot attached to a surface of the housing, wherein the retractable foot is to extend laterally with respect to the surface; and
a heat dissipation section at the surface, wherein the retractable cover the heat dissipation section in a first position.

8. An electronic device according to claim 7, further comprising a connection member to attach the retractable foot with the surface.

9. An electronic device according to claim 7, further comprising a conduit, wherein the conduit includes a first magnet and a second magnet.

10. An electronic device according to claim 9, wherein the first magnet is to hold the retractable foot in the first position, and wherein the second magnet is to hold the retractable foot in a second position.

11. An electronic device housing, comprising:
a foot assembly;
a grip assembly, wherein the grip assembly is to hold the foot assembly in a first position and in a second position; and
a heat dissipation section, wherein the foot assembly is to cover the heat dissipation section in the first position.

12. An electronic device housing according to claim 11, wherein the foot assembly comprises a connection member.

13. An electronic device housing according to claim 12, further comprising a conduit to connect the connection member with a surface of the housing.

14. An electronic device housing according to claim 13, further comprising screws to connect the conduit with the surface of the housing.

15. An electronic device housing according to claim 11, wherein the grip assembly comprises a first set of magnets and a second set of magnets, wherein the first set of magnets is to hold the foot assembly in the first position and the second set of magnets is to hold the foot assembly in the second position.
